(19) United States
(12) Patent Application Publication
(10) Pub. No.: US 2009/0083840 A1
(43) Pub. Date: Mar. 26, 2009

(54) INFERENCE SEARCH ENGINE SECURITY

(75) Inventors: Robert JENSEN, Fredericia (DK); Anders Lehmann, Holstebro (DK)

Correspondence Address: PILLSBURY WINTHROP SHAW PITTMAN, LLP, P.O. BOX 10500, MCLEAN, VA, 22102, US

(73) Assignee: Vertigo Netcare AS, Fredericia (DK)

(21) Appl. No.: 12/206,962

(22) Filed: Sep. 9, 2008

Related U.S. Application Data
(60) Provisional application No. 60/975,433, filed on Sep. 26, 2007.

(51) Int. Cl. H04L 9/32; G06F 17/30; G06N 5/02

(52) U.S. Cl. 726/6; 707/9; 706/47; 707/3; 707/E17.014; 707/E17.032; 707/E17.005

(57) ABSTRACT

In some aspects of the invention, a method for determining access to data stored within one or more databases is described. The method includes the aspects of receiving a user request from a user at an inference engine for access to the data, wherein the inference engine is in communication with a rules database, including one or more rules governing access rights to the data. Moreover, the method includes the aspects of creating a user credential based on the application of one or more of the rules to a identity information related to the user. Further, the method includes the aspects of comparing the created user credential and the user request at the one or more databases to determine whether the user meets the access rights for retrieving the data. Furthermore, the method includes aspects of determining an answer as to whether the access of the data is permitted or denied.

### CROSS-REFERENCE TO RELATED APPLICATIONS

This application claims priority to U.S. provisional application Ser. No. 60/975,433, filed Sep. 26, 2007, and further relates to U.S. provisional application No. 60/951,322, filed Jul. 23, 2007, the entire contents of both of which are herein incorporated by reference in their entirety.

### BACKGROUND OF THE INVENTION

The present invention relates to the use of an inference engine to provide a response to electronic queries.

### DESCRIPTION OF RELATED ART

Conventional database systems can include an inference engine that processes instructions within the limitation of a provided set of rules. Conventional database systems can also utilize a plurality of tables to store information such as users, relationship of users, and access privileges of users. Tables can also store information related to other databases within or outside of a collection of databases. A Federation is one example of such a database system.

In the context of a search engine, this tabled information is typically referred to as a pointer, as it points to a specific database location. In non-relational “hierarchical” and “network” databases, records in one file contain embedded pointers to the locations of records in another, such as customers to orders and vendors to purchases. These are fixed links set up ahead of time to speed up daily processing. Another type of non-relational database is the object database, which stores data consistent with their object model.

For example, in a traditional approach to implementing a Federated Configuration Database (FCMDB), the federation of data sources is established by fixed pointers to the additional data sources. This enables a single point of access to a repository consisting of multiple data sources. Conventional systems and methods for electronic searching of information typically rely on the structure of such database systems.

Search engines have been employed to assist a user to locate information on, for example, their hard drive, a local area network, wide area network, or even the internet as a whole.

Routine queries to a relational database often require data from more than one file. For example, to obtain the names of customers who purchased a particular product, data must be extracted from both the customer and order files. A relational DBMS has the flexibility to join two or more files by comparing key fields such as account number and name and generating a new file from the records that meet the matching criteria. In practice, such a pure relational query can be very slow. In order to speed up the process, indexes are built and maintained on the key fields used for matching.

While much progress has been made in this field, improvements to search engines are being realized all the time.

### BRIEF SUMMARY OF THE INVENTION

In some aspects of the invention, a method for determining access to data stored within one or more databases is described. The method includes the aspects of receiving a user request from a user at an inference engine for access to the data, wherein the inference engine is in communication with a rules database, including one or more rules governing access rights to the data. Moreover, the method includes the aspects of creating a user credential based on the application of one or more of the rules to a identity information related to the user. Further, the method includes the aspects of comparing the created user credential and the user request at the one or more databases to determine whether the user meets the access rights for retrieving the data. Furthermore, the method includes the aspects of determining an answer as to whether the access of the data is permitted or denied.

In some aspects of the invention, a method for determining access to data stored within one or more databases is described. The method includes the aspects of receiving a user request coupled with a user identity information from a user at an inference engine for access to the data, wherein the inference engine is in communication with a rules database, including one or more rules governing access rights to the data. Moreover, the method includes the aspects of identifying the data responsive to the user request. Further, the method includes the aspects of comparing the one or more rules to the data and the user identity information. Furthermore, the method includes the aspects of determining an answer as to whether the access of the data is permitted or denied.

Other objects, aspects, and advantages of the present invention will become apparent from the following description, the accompanying drawings, and the appended claims.

### BRIEF DESCRIPTION OF THE DRAWINGS

FIG. 1 is a block diagram of a system in accordance with some aspects of the present invention.

FIG. 2 is a flow chart illustrating a process fulfilling a user query using the system of FIG. 1 in accordance with some aspects of the present invention.

FIG. 3, a continuation of FIG. 2, is a flow chart illustrating a process fulfilling a user query using the system of FIG. 1 in accordance with some aspects of the present invention.

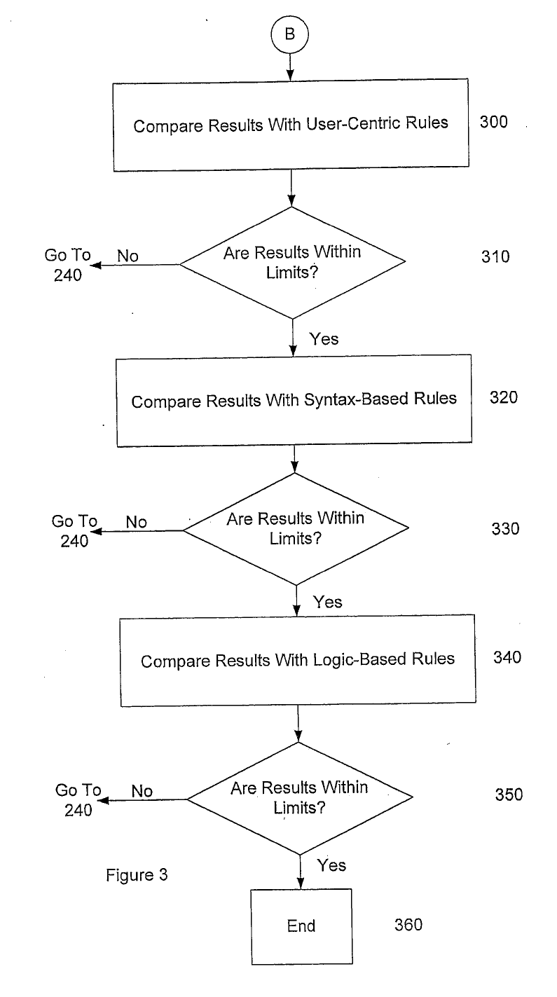

FIG. 4 is a block diagram of a system in accordance with some aspects of the present invention.

FIG. 5 is a flow chart illustrating a process fulfilling a user query using the system of FIG. 4 in accordance with some aspects of the present invention.

### DETAILED DESCRIPTION OF THE INVENTION

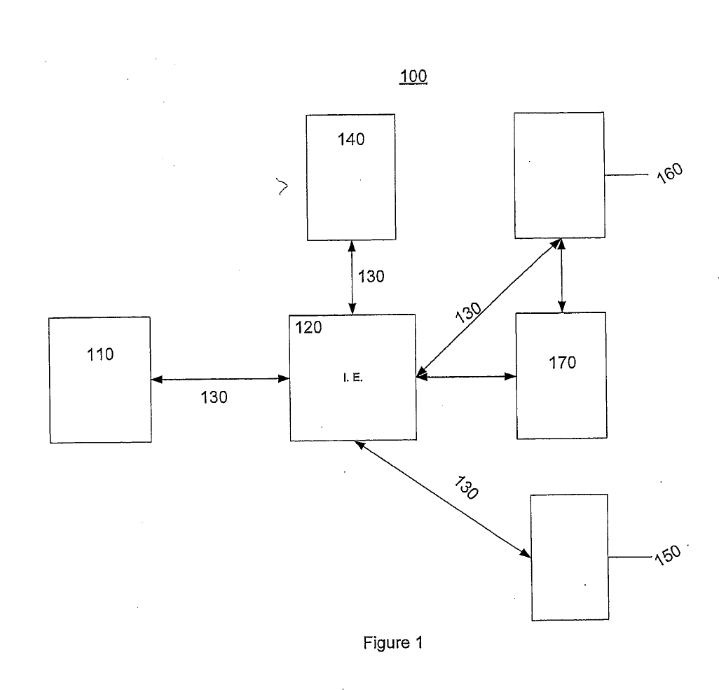

FIG. 1 illustrates a block diagram in accordance with an aspect of the present invention indicated generally by 100. An input 110 is transmitted to an inference engine 120. In some aspects of the invention, the input 110 may be a query manually entered in a computer or an interface device, which is transmitted to the inference engine 120 through a network 130. In other aspects of the invention, the input 110 may be a query from another computer.

The inference engine 120 is in communication with at least one database, for example, a relational database. A relational database is a database that maintains a set of separate, related files, but combines data elements from the files for queries and reports when required. In an aspect of the invention, the inference engine is in communication with a primary database 140 and at least one secondary database 150. The inference engine 120 is also in communication with a registry 160. In an aspect of the invention, the registry 160 is a semantic Universal Description Discovery and Integration (SUDDI) registry. Other types of registries could be used. The registry 160 is configured to contain as well as update information related to data stored in the primary database 140 and the at least one secondary database 150. The registry 160 may be further configured to update the information in substantially real time or near real time. In an aspect of the invention, the registry 160 is a stand-alone module; however, in other aspects, the registry 160 is logical structure in communication with the inference engine 120. In an aspect of the invention, the network 130 may be a wired or wireless wide or local area network as would be apparent to one of ordinary skill in the art, and the invention is not limited to any specific type.

The inference engine 120 is configured to access a set of rules with which it is enabled to operate. These rules may reside within the inference engine 120 itself or accessibly outside the inference engine 120 as would be apparent to one of ordinary skill in the art. The input 110 is received by the inference engine 120 and is parsed into in at least one subsequent-query. Each subsequent-query is analyzed against the set of rules, which dictate how the subsequent-queries are processed. By way of non-limiting example, the rules can be generally categorized into the following: user-centric, syntax-based, logic-based, and semantic-based. As would be apparent to one of ordinary skill in the art, other categories of rules, such as fuzzy logic-based rules, can also exist.

The user-centric rules might include security rules and/or regional rules. For example, different users may have different levels of security authorization. Furthermore, security may be based on an authorization level of different users' classifications, where one class of users may be authorized to perform a restricted level action while another class of users may be authorized to perform an unlimited level action. In response to a user-submitted query in such an instance, the system will refer to the user-centric security rules and would only return information appropriate to the users' authorization level. This may be implemented using, for example, a secure user identification, pin code, IP address identification, or any other user identification system or method as would be apparent to one of ordinary skill in the art. An example of a regional, user-centric rule may include rules that address a user's country code so that the system returns information relevant to and conforming with the local currency and/or time zone.

The syntax-based rules might include instructions, or algorithms, configured so that a required category of information is returned within the same category and/or rejects information outside of that category. For example, if a requested query category relates to currency, then the rules would only allow a currency answer. Such rules can be general, for example, where only numerical answers are returned (or preferred) for categories such as “currency.” Such rules can also be more specific, for example, where only answers that conform to a currency format are returned (or preferred) for categories such as “currency.”

The logic-based rules might include instructions, or algorithms, that analyses results based on a set of user-defined criteria. This user-defined criteria allows users to set likely expected range values so that returned results that are outside of this predefined range will be rejected and not returned to the user. It should be noted, however, that such “ranges” are not defined herein to exclude non-numerical results. Instead, a predefined range can include any parameters, for example, a range of colors, names, or any other criteria as would be apparent to one of ordinary skill in the art.

The semantic-based rules might include instructions, or algorithms, that takes each subsequent-query and performs a semantic analysis to create additional related terms for each subsequent-query. For example, if the subsequent-query was “license,” then the semantic logic would search for and find related terms with which to search the primary database 140 and the at least one secondary database 150. In this example, terms such as “contract” and “agreement” could be combined with the original subsequent-query “license” to be matched against the registry 160. Based upon the results of the matching, the inference engine 120 will query the appropriate database 140, 150. The database 140, 150 will return the results to the inference engine 120 and, ultimately, the user.

It should be understood that there may be other rules categories and other examples of rules within each category. (For example fuzzy logic-based rules, as would be apparent to one of ordinary skill in the art.) It should also be understood that the application of rules by the inference engine is not exclusive to the employment of other rules. By way of non-limiting example, once the semantic based-rules are consulted, the user-centric rules may determine if the results are being returned in the correct regional format, the syntax-based rules may determine if the results are of the same category as the original subsequent-query and additional semantic terms, and the logic-based rules may also determine if the results conform to an expect result range.

The database 140, 150 may include a primary database and a secondary database. However, it should be understood that system may include a plurality of primary databases. The system may also include a plurality of secondary databases. The collection of a plurality of databases may be, for example, what is known in the art as a Federation of databases. It should be understood, however, that the plurality of databases can by any form of data storage that is networked together, wired or wireless, through a WAN or LAN, or through the Internet. As would be apparent to one of ordinary skill in the art, a database can be, by way of non-limiting example, a magnetic storage device or an optical storage device, but may also be any device capable of storing data accessible to network 130 or inference engine 120.

As would be apparent to one of ordinary skill in the art, the registry 160 could reside within any database 140, 150. Similarly, the registry 160 may also exist as and/or within a module or medium separate from database 140, 150.

By way of non-limiting example, and as would be apparent to one of ordinary skill in the art, a subsequent-query can be the result of a set of instructions, algorithm, and/or filtering rules 170. Such filtering rules can reside inside registry 160 or exist separate from registry 160 but is accessible via network 130. For example, the initial electronic query would have a certain scope. Said instructions, algorithms, and/or filtering rules 170 can be configured to create one or more subsequent-query with a scope more conditioned to providing an answer to the subsequent-query or the initial electronic query commensurate with the scope of the subsequent-query or the initial electronic query. In addition, it would be apparent to one of ordinary skill in the art that the subsequent-query could, in fact, be as broad or broader than the initial electronic query. Of course, the subsequent-query could also be narrower in scope that the initial electronic query.

In addition, another exemplary implementation may further parse a subsequent-query into a third, extended query whose scope may also be narrower, as broad, or broader than its parent queries. In other words, it would be apparent to one of ordinary skill in the art that extended queries (e.g. subsequent-queries, tertiary-queries, and so on . . . ) need not be narrower than the queries from which they evolve. By way of non-limiting example, parsing a query that includes a request for license information into a query for license, agreement, or contract information is at least as broad, if not broader, than the parent request, which was limited to “license information.” As a result, extended, child queries clearly do not require that they be narrower in scope than their parent queries. Such parsing of a query can be achieved through any of a number of known methods.

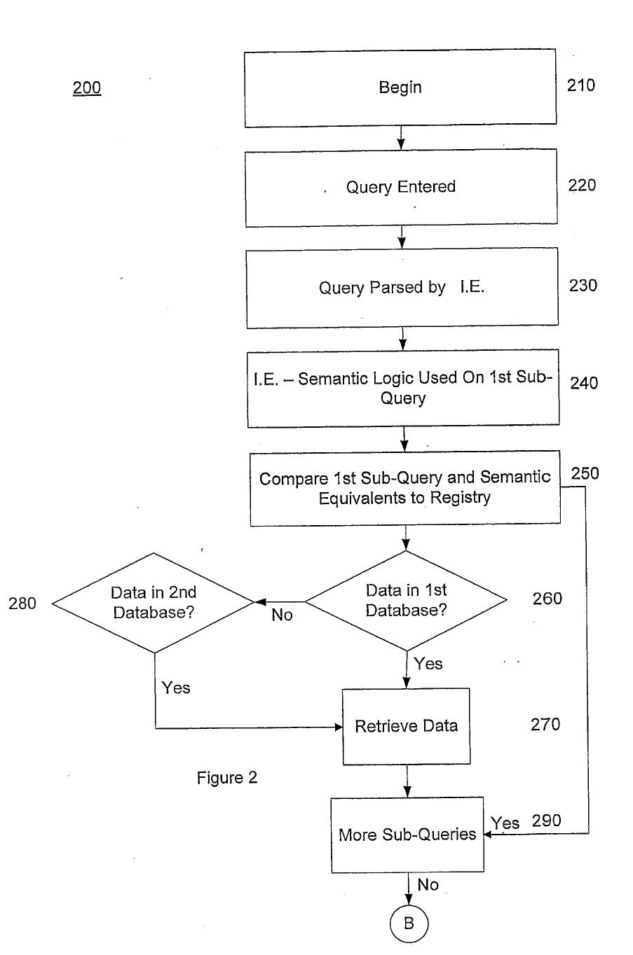

Referring now to FIG. 2, indicated generally by 200 is a flow chart illustrating a process in accordance with an aspect of the present invention fulfilling a user query using the system of FIG. 1. The process begins at 210 where a query is entered 220 into the inference engine 120. The query can include one or more subsequent-queries. To that end, the query is parsed and interpreted 230 into at least one subsequent-query. For the first subsequent-query, the inference engine 120 invokes the semantic logic and, within the set of rules, performs a semantic search 240 to identify related terms that are to be combined into the first subsequent-query. The first subsequent-query is compared 250 against the registry 160 to identify the location of the database which contains information related to the first subsequent-query. If the related information is found to be located in a primary data resource 260, the inference engine 120 performs a data request operation to retrieve the desired information 270. If the related information is found to be located in the at least one secondary database 280, the inference engine 120 performs a data request operation across network 130 to retrieve the desired information 270. The process is repeated on all subsequent subsequent-queries of the original query until all are searched 290.

The results from the first subsequent-query are transmitted to the inference engine 120, which invokes the user-centric, the syntax-based, and the logic-based rules to analyze the results. The user-centric rules 300 determines whether the results conform to, for example, the regional settings of the requesting user. If the results are within the specified limits 310, then the results are compared against the syntax-based rules. If they are not within limits 310, then the inference engine 120 passes the subsequent-query back to process 240. For example, if the first subsequent-query involved information related to the cost of a license agreement for a software package and the user's regional settings where set to U.S. (or detected to be U.S.), then the user-centric rules would determine if the results are in U.S. currency. If the results matched the regional settings, then the results would pass the user-centric rules; however, if the results were in Japanese Yen, then the user-centric rules would notify the inference engine 120. The inference engine could then convert the returned results into the format expected by the user or may invoke another process to perform the required conversion.

The syntax-based rules 320 determines whether the results conform to the category of information requested in the first subsequent-query. If the results are within the specified limits 330, then the results are compared against the syntax-based rules. If they are not within limits 330, then the inference engine 120 passes the subsequent-query back to process 240. Continuing with the example above where the query was for the cost of a license agreement, the expected category of information is currency. The syntax-based rules would determine whether the results are in a currency format and, if so, the results would pass the syntax-based rules. If the result are not in the proper category, the inference engine 120 will perform an operation to analyze the first subsequent-query using the semantic-based rules and begin the process again.

The logic-based rules 340 determines whether the results conform to the pre-defined user criteria. If the results are within the specified limits 350, then the results are compared against the logic-based rules. If they are not within limits 350, then the inference engine 120 passes the subsequent-query back to process 240. Still continuing with the example above, the expected result is a currency value and the likely amount that has been pre-defined for a single license is between US $50.00-$500.00. If the result is US $150.00, then this amount is determined by the logic-based rules to be acceptable. However, if the result is US $1.00, then this amount is outside of the pre-defined criteria and the inference engine 120 will perform an operation to analyze the first subsequent-query using the semantic-based rules and begin the process again.

In an aspect of the invention, inference engine 120 is configured to perform an analysis of the first subsequent-query and subsequent subsequent-queries contemporaneously. In other aspect of the invention, the inference engine 120 completes the first subsequent-query operation before initiating the subsequent subsequent-query operations. Once the first subsequent-query and subsequent subsequent-query operations are complete and the each result has passed the above rules, then the results are aggregated and transmitted to the user. However, it should be understood that it may be desirable to have the results returned to the user (or requesting computer) as they are received by the inference engine 120. This might, for example, allow for faster results as once the user is satisfied, the user can stop the entire process.

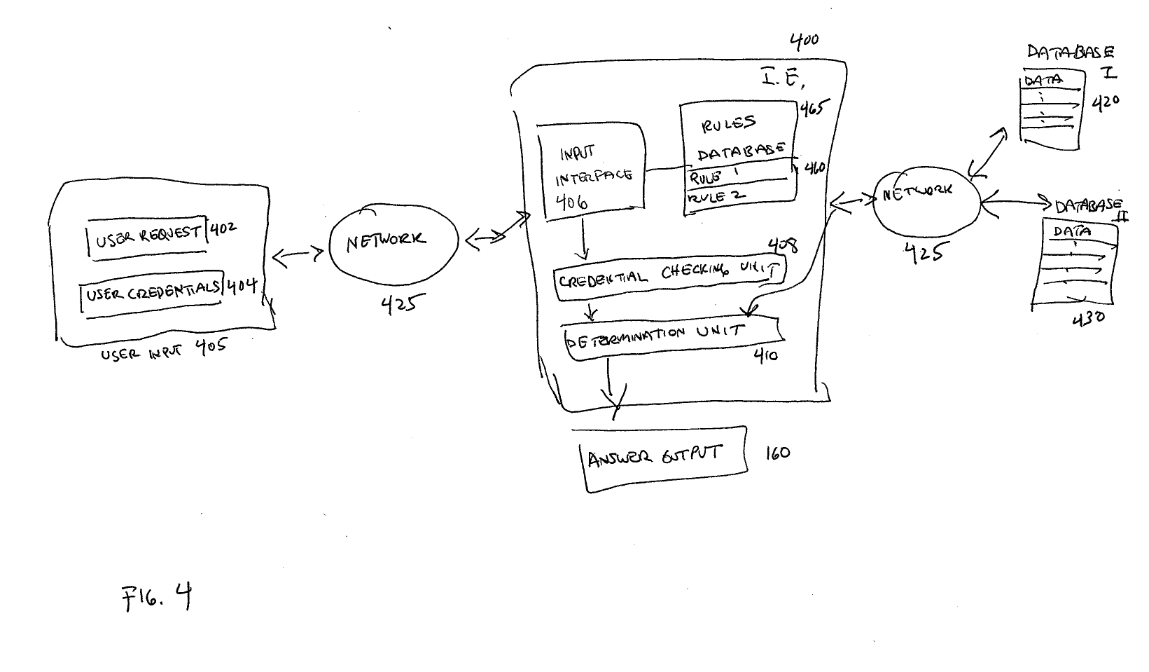

FIG. 4 is similar to FIG. 1, which illustrates a system having enhanced security. In some aspects of the invention, a user request 402 is associated with a user identity information such as a user credential 404, which are combined into a query 405 that is received by an inference engine 400. The user credential 404 identifies a security level of the user and may utilize a symmetric and/or an asymmetric cryptographic protocol. For example, the user credential 404 may include a private cryptographic key encrypted with a symmetric key. Other forms for user authentication can be used such as the user registering and logging in with a trust third party authentication service. Such trusted authentication service are well known in the art and include, for example, the Kerberos protocol developed by MIT and Active Directory provided by Microsoft Corporation. Other cryptographic protocols including authentication protocols may be used to register and authenticate the user as would be apparent. The user request 402 that is associated with the user credentials is received by the inference engine 400 at a input interface 406. The user request 402 can be processed by the inference engine 400 in a manner similar to that described in relation to FIG. 1.

The inference engine 400 contains a rules database 465 that includes a dynamic set of security rules 460. The security rules 460 can be applied to further create, define, or otherwise change a set of security levels or user credentials that are associated with a particular user or group of users. The security rules 460 can also be applied to data being requested by the user's request. The rules database 465 can be a component of the inference engine 400 or can be a located separately and can communicate with the inference engine 400 through either a wired or wireless network 425 as would be apparent. This set of security rules can be modified manually or automatically as would be apparent to one of ordinary skill in the art.

The databases 420, 430 contain a plurality of data folders, wherein each data folder contains a plurality of data files. Either or both of the databases 420, 430 can be local to the inference engine 400 or can be a located separately and can communicate with the inference engine 400 through either a wired or wireless network 425 as would be apparent. In some aspects of the invention, certain portions of data within a data file or group of data files can require additional security. For example, a person's social security number or a financial account number can be are identified within the file to be particularly sensitive and requiring additional safeguards from unauthorized access. As such, these particular sensitive data strings within a file are associated with a security marker indicative of the security level a requesting user must have. Also, the data file or the group of data files containing the sensitive data may have a particular attribute in common, such as a common author, theme, or file type that may be searched for to unintentionally reveal sensitive data. The security marker may include one or more security levels, wherein the security levels determine the usage rights for manipulating a particular data file or group of files. For example, a security level 1 would be the least restrictive permitting anyone to request and receive the data while a security level 3 would be the most restrictive permitting only a select group of individuals to request and receive the data. In this example, a security level 2 would be properties allowing an intermediate level of restriction upon the data. The usage rights includes rights such as which users are able to view and/or modify the contents of the data.

The usage rights can be determined within the inference engine 400 or within the search query. If the determination is made in the inference engine 400, a credential checking unit 408 and a determination unit 410 is employed. The credential checking unit 408 performs a cryptographic operation upon the received user credential to determine the security level of the user. For instance, if the user credential is encrypted with a cryptographic key, either a symmetric or asymmetric private key, the credential checking unit 410 invokes a decryption protocol and decrypts the encrypted user credential using either the symmetric key or the asymmetric public key of the user. The determination unit 410 compares the security level retrieved from the credential checking unit 408 with the security level associated with the retrieved data from databases 420, 430 or with the user's security level as described in the security rules 460 within the rules database 465.

In some aspects of the invention, the determination is made with the search query. The inference engine 400 determines the security level of the user, as described above, and compares the determined security level with an appropriate rule or set of rules 460 stored within the rules database 465. Based on this comparison, the inference engine 400 passes the user query along with the user's security level to the databases 420, 430. The query compares the security level of the data to be retrieved with the user's security level. If the security level of the data is within the security level of the user, then the data is transmitted back to the inference engine 400 and then onto the user. If the security level of the data is not within the security level of the user, then the user is sent a message by the inference engine 400 that the data being requested is not within the security level of the user.

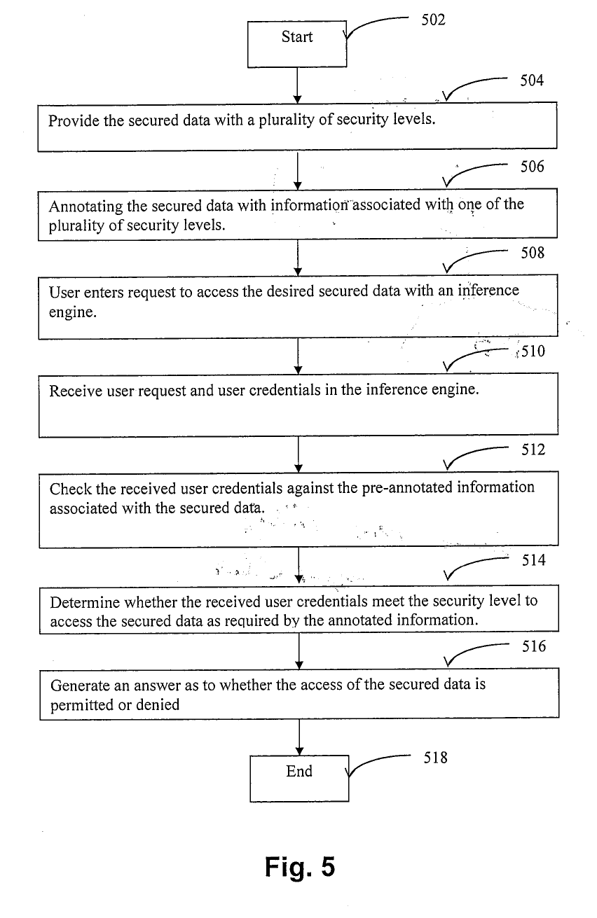

Referring now to FIG. 5, indicated generally by 500 is a flow chart illustrating a process in accordance with some aspects of the present invention fulfilling a user query using the system of FIG. 4. The process begins at 502 and at step 504 the data or group of data within a particular data folder is annotated with a one of the plurality of security levels. At step 506, the user enters a request with the user's security credential into the inference engine. The inference engine receives the user's request and security credential at 508 and determines, based on the received security credential and data stored in the rules database, what data the user can access at 510. The inference engine queries the databases to retrieve data relating to the user's query and determines whether the user can access the retrieved information based upon the received security credential at 512. If the user has requested data which is beyond the user's security level, the inference engine will notify the user at 514. The data that is within the user's security level is then made available to the user through the inference engine at 516.

Still referring to FIGS. 4 and 5, a dynamic user credential object 404 associated with the query 402 is used to protect certain information from unauthorized access. By way of non-limiting example, said information can be located within a data file, exist as a data file, group of data files, and/or exist as metadata to a data file. The system can preferably protect the information from unauthorized access regardless of its location.

In one or more aspects, certain information, no matter where located in the system, may be responsive to the query but it may not be desired that the certain information be returned to the user making the query. By way of non-limiting example, an organization may not wish certain information to be accessed by certain individuals, for example, salary information, trade secret information, or even birthdates. In one or more aspects, a user credential object 404 is created by inference engine 400 and during the query of the at least one database the credential checking unit 408 and/or determination unit 410 will compare the information to the user credentials 404 and the query 402 in order to determine whether the user may have access to the information. In doing so, the inference engine 400 can compare the information as well as the context of the information, such as the name of the containing data file, author of the data, as well as the information, such as text, surrounding the data.

In one or more aspects, the user credentials 404 are a set of rules that are dynamic and can be changed manually or automatically. In addition, there may be additional rules that govern the set of rules. By way of non-limiting example, it is possible an organization will only allow users in the human resources group to access other employee's salary information. This salary information can take many forms. Inference engine 400 will analyze all information during or after a query to ensure that non-human resources personnel are not able to access the salary information, regardless of where located or how many times within the system the information appears. In addition, however, there may be additional rules that govern the security of, for example, the salary information mentioned above. By way of non-limiting example, a rule may exist, or may be entered manually, that in the event that all human recourses personnel are unavailable, then Employees A, B, and/or C, may, for a limited period of time, have access to said salary information.

In one or more aspects, the one or more rules within the rules database are dynamically and/or globally updated. By way of non-limiting example, it is possible that on occasion the rules will need to be updated to account for the changing needs of users, while still providing the need security to the data. Instead of annotating the data, or in combination with, the rules are globally changed to effect the access rights within the databases. This provides an improvement by reducing the complex and time-consuming task of annotating the data within a particular data file within a database. By way of non-limiting example, a rule can be globally updated by specifying any data string having a format like a government serial number is not accessible to anyone not having the highest security clearance.

One or more embodiments or aspects of the present invention may be used with the system described in U.S. Provisional Application Ser. No. 60/871,479, the entirety of which is incorporated herein by reference. Thus, the invention may be used to query, access and retrieve data from a database containing profile of various service and process objects in a network with a service oriented architecture.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for determining access to data stored within one or more databases comprising:
receiving a user request from a user at an inference engine for access to the data, wherein the inference engine is in communication with a rules database, including one or more rules governing access rights to the data;
creating a user credential based on the application of one or more of the rules to a identity information related to the user;
comparing the created user credential and the user request at the one or more databases to determine whether the user meets the access rights for retrieving the data; and
determining an answer as to whether the access of the data is permitted or denied.

2. The method of claim 1, wherein the one or more of the rules are dynamic enabling update in substantially real-time.

3. The method of claim 1, wherein the one or more of the rules are global enabling the access rights governed by the rule to be changed for all the data.

4. The method of claim 1, further including
registering data stored in one or more databases to the inference engine, wherein the registering includes providing a description of the stored data to the inference engine.

5. The method of claim 4, wherein the registering includes filtering the data stored in the one or more database to determine which data requires security.

6. The method of claim 5, wherein the filtering includes comparing each data string within the data against a pre-determined format.

7. The method of claim 1, wherein the determining an answer includes returning the data requested in the user query.

8. The method of claim 1, wherein the determining an answer includes returning a subset of data requested in the user query.

9. The method of claim 1, wherein the data or a portion of the data stored in the one or more databases is annotated with access rights information.

10. The method of claim 1, wherein the access rights include one or more access rights levels.

11. A method for determining access to data stored within one or more databases comprising:
receiving a user request coupled with user identify information from a user at the inference engine for access to the data, wherein the inference engine is in communication with a rules database including one or more rules governing access rights to the data;
identifying the data responsive to the user request;
comparing the one or more rules to the data and the user identity information; and
determining an answer as to whether the access of the data is permitted or denied.

12. The method of claim 11, wherein the one or more rules are dynamic enabling update in substantially real-time.

13. The method of claim 11, wherein the one or more of the rules are global enabling the access rights governed by the rule to be changed for all the data.

14. The method of claim 11, further including
registering data stored in one or more databases to the inference engine, wherein the registering includes providing a description of the stored data to the inference engine.

15. The method of claim 14, wherein the registering includes filtering the data stored in the one or more database to determine which data requires security.

16. The method of claim 14, wherein the filtering includes comparing each data string within the data against a predetermined format.

17. The method of claim 11, wherein the determining an answer includes returning the data requested in the user query.

18. The method of claim 11, wherein the determining an answer includes returning a subset of data requested in the user query.

19. The method of claim 11, wherein the data or a portion of the data stored in the one or more databases is annotated with access rights information.

20. The method of claim 11, wherein the access rights include one or more access rights levels.
